(19) United States
(12) Patent Application Publication
(10) Pub. No.: US 2018/0283734 A1
(43) Pub. Date: Oct. 4, 2018

(54) Solar collection apparatus with elongated slats, integrated tracking and decoupled axes

(71) Applicant: Elliot Tarabour, Clarendon Hills, IL (US)

(72) Inventors: Elliot Stewart Tarabour, Clarendon Hills, IL (US); David Shaw, Waterford, WI (US)

(73) Assignee: Elliot Tarabour, Clarendon Hills, IL (US)

(21) Appl. No.: 15/932,599

(22) Filed: Mar. 19, 2018

Related U.S. Application Data
(60) Provisional application No. 62/601,486, filed on Mar. 24, 2017.

(51) Int. Cl. F24S 50/20; F24S 25/63; H02S 20/32; H02S 30/10

(52) U.S. Cl. CPC F24S 50/20; H02S 30/10; H02S 20/32; F24S 25/63

(57) ABSTRACT

We have done a zero based analysis of the solar energy field and have found that an elongated surface area will reduce energy required for solar tracking. We have constructed a device which uses this geometry and simultaneously tracks the sun in two dimensions. The tracking is done independently. This integrated solar energy collection device is the invention disclosed in this application.

This application is a non-provisional follow up to provisional application 62/601,486 dated Mar. 24, 2017. This application takes priority from the provisional filing.

### BACKGROUND

Solar trackers are used to enhance the efficiency of solar devices but at an additional cost. There are a variety of ways this can be accomplished via single axis tracking or dual axis tracking. Trackers must be used in concentrating applications but their use with traditional flat plat solar cells is strictly a matter of economics. An improved metric of insolation is measured against an increased initial capital expense along with operation and maintenance costs to determine the economic viability. Historically the cost of the photovoltaic cells comprised the majority of the expense in solar devices. We therefore find that the commercial trackers now in use conformed to the standard panels which emerged as the industry developed as to make compatibility among components easier. However, since the economics have shifted, we have redesigned the collection of solar energy from scratch to reduce energy consumption and have the geometry of the collecting surface conform to the tracking function instead of having the tracking conform to a standard PV panel used by the solar industry. This is based on the fact that the overwhelming majority of the tracking motion is daily tracking and the moment of intertia for an rigid body is a function of the radius of rotation squared. We embody this principle in the device disclosed by this application to provide a new and improved method of collecting solar energy. In addition, by decoupling the axes, we have made a simpler apparatus and integrating the tracking into the device a priori, instead of having tracking as an adjunct. We feel this will produce better economics and further reduce the cost of solar devices intended to collect solar energy and convert it to electricity. A single axis tracker is implicit in this where longitudinal tracking is not performed and the device remains at an optimal fixed tilt.

### PRIOR ART

The only relevant existing patent that may have similarity to the present disclosure Is US81199663B2 Scanlon High Efficiency Counterbalanced Dual Axis Solar Tracking Array Frame System.

This patent is similar in the mechanism for decoupling the axes. It is distinguished by the fact that it is designed for standard solar panels and the system is intended to be for tracking only rather than an integrated collection device.

As use of standard solar panels have become traditional in the industry, we feel that this disclosure is set apart from other methods of tracking in that it contradicts the conventional wisdom by introducing elongated slats as an alternative.

### BRIEF SUMMARY OF THE INVENTION

The apparatus tracks sunlight in both the longitudinal and latitudinal axes but does so via decoupled and completely independent mechanisms. The novel component of this zero based analysis, is the realization that the minimal angular momentum occurs when the photovoltaic surface area is extremely elongated so the thinner dimension is used for daily tracking and the longer dimension is used for seasonal tracking. An explanation is demonstrated by FIG. 5. This figure demonstrates that the angular momentum is minimized by using long thin surfaces to collect the solar energy. By analogy, venetian blinds may be used as a conceptual reference point. This suggests that the shape of the PV surface should follow the geometric-physical principle rather than the tracking being an adjunct to an industry standard panel or array of these panels. The tracking motion is accomplished by use of linear actuators which translates circular motion into linear motion and keep the PV surface perpendicular to the sun maximizing their efficiency in 2 dimensions.

### BRIEF DESCRIPTION OF THE DRAWINGS

FIG. 1. shows a side and top view of the lower frame

FIG. 2. shows a side and top view of the upper frame and detail of sleeves to prevent binding

FIG. 3. shows the detail of the electrical wiring on a single slat

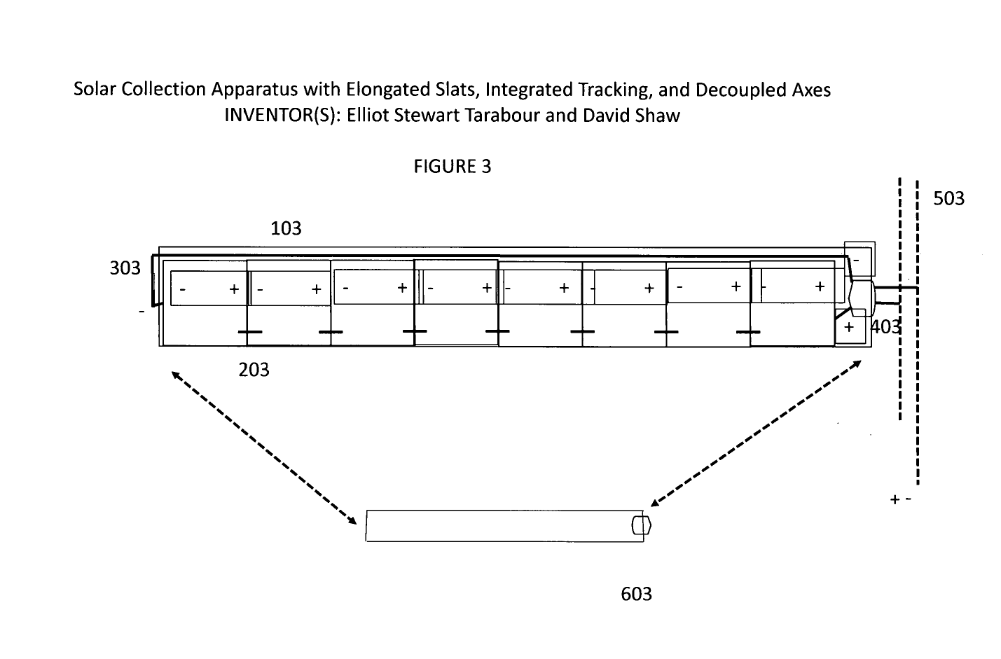

FIG. 4. shows the side and top of the full apparatus including slats

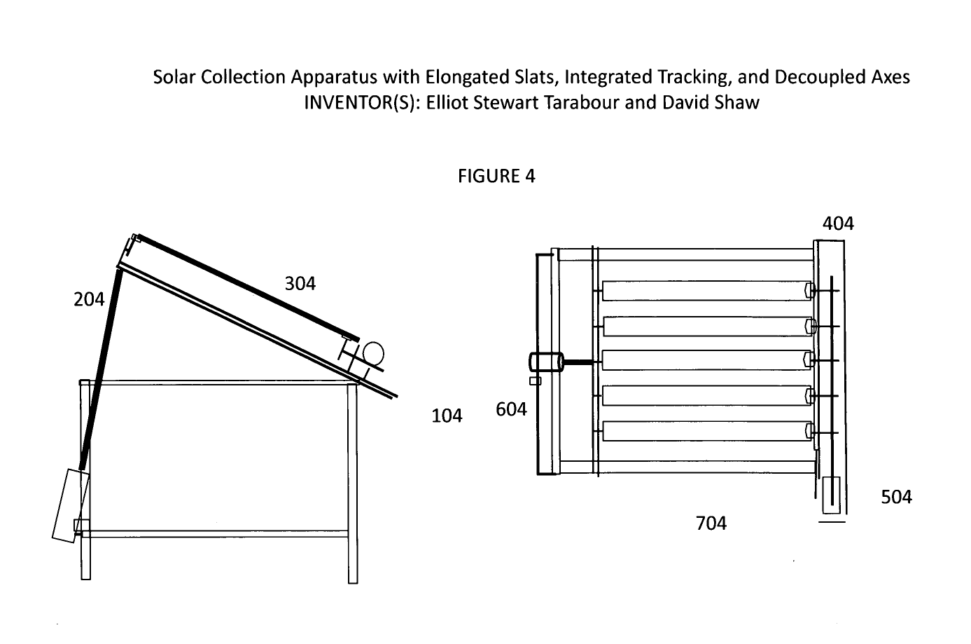

FIG. 5. Show the physics involved in the geometry of the tracker design

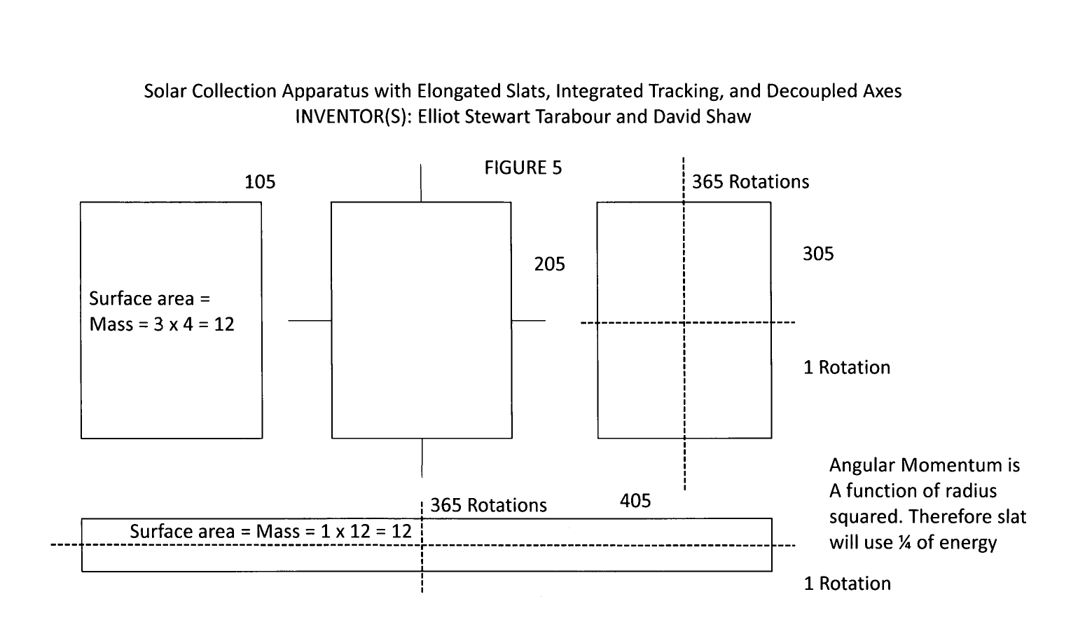

### DETAILED DESCRIPTION AND EMBODIMENT OF IMPLEMENTATION

The following is a detailed description of the embodiment of the device disclosed in the application. It is however instructive to stipulate that all individual components used are prior art and no claim is made that these individual components are part of this disclosure. For example: a fastener may be a bolt, screw, nut, or whatever is appropriate for construction.

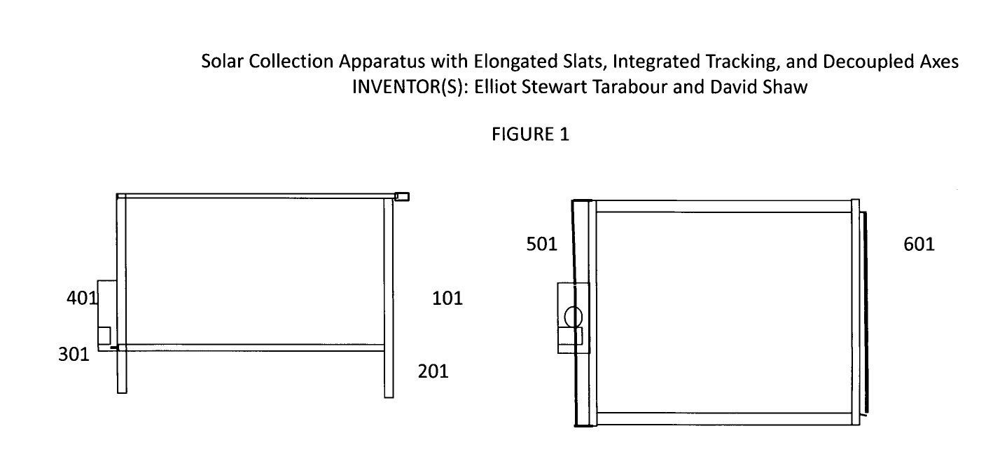

We begin by constructing the lower frame as in FIG. 1. This consists of 4 legs attached to rigid rods that form a table top as depicted in 101. Additional support may be added 201 to ensure stability. A pole 501 is attached to the northern side of the lower frame by which the larger actuator 301 which is used to control longitude is attached so that it can remain perpendicular with the upper frame to avoid binding, A tray 401 is attached to hold a microprocessor which will control the motion of both the small and large actuator which are used to maintain the surface of the slats at maximum perpendicularity to the sun. This microprocessor takes the longitude as input and calculates the correct longitude and latitude using the equation of motion. The microprocessor is connected to the actuators as output devices. Attached to the south side of the device is a piano hinge 601 to attach the upper frame so it may pivot with the correct longitude.

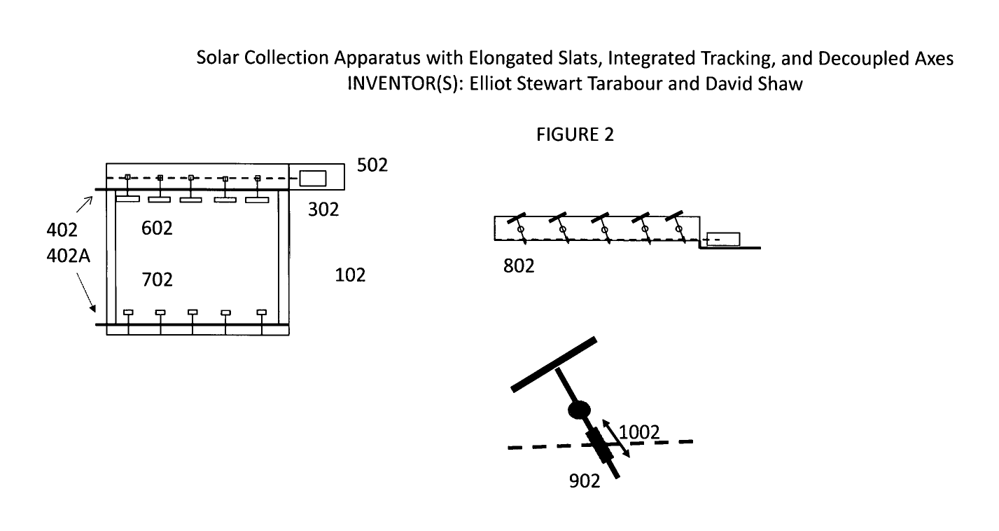

The upper frame (FIG. 2) is constructed by creating a rectangle of rigid rods similar in dimension to the lower frame 102. On the north and south sides upward facing rectangular pieces are added 402 and 402A to contain the pivot rods as shown in 802, There is a tray added to the south side which will contain the smaller actuator 502 which will create the linear motion for daily tracking by the slats. The linear actuator engages with each slat at the bottom to create the motion that is translated to the slats at the top 602 and 702. The actuator is on a tray extending beyond the rectangular frame 302. Since the individual cells rotate around a pivot point we need to include a sliding sleeve on each slat support structure 902 to avoid binding in the rigid rod that extends from the linear actuator. This is depicted in the motion in 1002.

We now show how a single slat is wired with individual PV cells 103. These cells are placed linearly along the length of the slat. The cells are connected serially with a tab or wire 203 which connects the negative of one cell to the positive of the adjacent cell giving a flow through the cells of a positive current. A wire 303 is connected to the cell at the end away from the side where the linear actuator and bus wire 503 and runs the length of the slat and attaches to a blocking diode 403. The diode is connected to the positive current through a wire. The diode connects to the bus wire 503 which aggregates current from all the slats. The connections are parallel. The slat will be attached to the upper frame at 602 and 702. There may be a very large number of slats 603 in a single device.

The final step in construction is attaching the upper and lower frames. The additional attachment of slats can be done either before or after this depending on logistics including most importantly the weight of the apparatus. The upper frame is connected to the lower frame in two points. The first is the piano hinge 601 which will allow the upper frame to pivot up and down with the change in latitude. The other is the rod attached to the larger actuator 204. The microprocessor is attached to the two actuators via conventional wiring or may communicate with these devices wirelessly.

1) We claim a device to collect solar energy and convert it into electricity consisting of a plurality of parallel elongated slats with photovoltaic cells on the surface mounted on a device that tracks the sun independently in two axes intended to maximize perpendicular exposure to the surface area and minimize energy expenditure.

2) We claim a device as described in claim 1 consisting of an indefinite plurality of slats and of arbitrary length determined by economic and engineering considerations

3) We claim a device as described in claim 1 where the slats are constructed from materials, including composites where strength, weight, and weather resistance are factored into the design and construction.

4) We claim a device as described in claim 1 which can be mounted on the side of a south facing structure.

5) We claim a device as described in claim 1 where the seasonal tracking can be automatic, manual, or non-existent,

6) We claim a device as described in claim 1 which incorporates the use of concentration in either 1 or 2 dimensions to reduce the footprint of photovoltaic cells required.
